(19) United States
(12) Patent Application Publication
(10) Pub. No.: US 2001/0052111 A1
(43) Pub. Date: Dec. 13, 2001

(54) Management of application programming interface interoperability

(75) Inventor: Daniel B. Scott, Toronto (CA)

Correspondence Address: Jeffrey S. LaBaw, International Business Machines, Intellectual Property Law, 11400 Burnet Rd., Austin, TX, 78758, US

(73) Assignee: International Business Machines Corporation, Armonk, NY (US)

(21) Appl. No.: 09/801,619

(22) Filed: Mar. 8, 2001

(30) Foreign Application Priority Data
Apr. 28, 2000 (CA) 2,306,974

(51) Int. Cl. G06F 9/44

(52) U.S. Cl. 717/1

(57) ABSTRACT

A computer system development tool for managing interoperability between client applications and server applications in differing APIs. The tool includes source code sample files having an index section, a conditional statement section, and a subroutine section. Each source code sample files is defined in a language conforming to one of the APIs. The subroutines in a source code sample file define by example the interoperability of the source code sample API with other APIs. The source code sample file conditional statement section sets out the varying interoperability constraints and the index permits a developer to locate sections of the source code sample file of interest for a given interoperability issue.

### FIELD OF THE INVENTION

The present invention is directed to an improvement in computing systems and in particular to an improvement in the management of application programming interface interoperability.

### BACKGROUND OF THE INVENTION

In a distributed computing environment, it is typical for a server application to be written using a particular application programming interface (API), while client applications may be written using a different API. Different APIs may provide different levels of support for their respective application systems. In addition, some APIs may support a given feature of the back end application system, but may not provide full interoperability with other APIs for other application systems in use in a heterogeneous client server context.

It is common that a system developer implements a computer system using an application with a defined API on a client system for interaction with a specified API on a server system. In such a case, API interoperability issues may arise. The developer typically relies on documentation provided with the APIs in question to determine the level of interoperability available and to develop computer code for the client API which conforms to the interoperability constraints which may exist for the different APIs.

Problems with this approach include the necessity for the programmer to consult different documentation sources, and the unwieldy and potentially unclear manner in which information pertaining to the interoperability of different APIs is presented.

Prior art systems have been described which include automated approaches to permit for interoperability between heterogeneous systems. For example, for object-oriented systems one such system is described in U.S. Pat. No. 5,732,270, Foody et al. The system includes object-oriented frameworks for defining proxy objects so that objects from a differing object-oriented environment may be used as if they were native objects in the environment of a given proxy object. Such a system is defined to operate dynamically to permit objects to be manipulated by manipulating the proxy object in a different environment. There is a complex set of frameworks defined to permit such a proxy object to be defined and used. Another such system permitting interoperability between applications is disclosed in U.S. Pat. No. 5,913,061, Gupta et al. This system requires an interchange server for transferring messages between connectors in respective applications and a defining the interoperability of the applications. Such approaches require a system to be installed and dynamically interact with the APIs to handle the interoperability between APIs. Alternative systems rely on the automated generation of source code based on detailed definitions of interface and communication information or script sources (see for example, Japanese Patents JP11073306 and JP11119986).

It is therefore desirable to have a tool to permit application programming interface interoperability to be managed efficiently without the need for a developer to research different interoperability information, to invoke a system to dynamically interact with the APIs, or to require detailed formal definitions to be created as a precondition to the automated generation of source code.

### SUMMARY OF THE INVENTION

According to one aspect of the present invention, there is provided improved management of application programming interface interoperability.

According to another aspect of the invention, there is provided a computer system development tool for managing the interoperability of differing application program interfaces, the computer system including a source code sample file written for a first application program interface and including subroutines defining successful interoperation with a second application program interface.

According to another aspect of the invention, there is provided the above computer system development tool in which the source code sample file further includes a conditional statement section including source code reflecting the applicability of the subroutines in the subroutine section to the permutations of client application program interface and server application program interface interoperation, and an index section including entries referring to the source code logic blocks in the conditional statement section.

According to another aspect of the invention, there is provided a computer system development tool for managing the interoperability between a set of client applications and a set of server applications where each of the set of client applications, and each of the set of server applications, is written to conform to a selected one of a set of application program interfaces, the computer system development tool including a collection of source code sample files, each of the source code sample files conforming to a target one of the set of client application program interfaces and including a subroutine section having subroutines exemplifying successful interoperation between the target client application program interface and each of the set of differing server application program interfaces, a conditional statement section including source code reflecting the applicability of the subroutines in the subroutine section to the permutations of client application program interface and server application program interface interoperation, and an index section including an index of the subroutines in the subroutine section.

According to another aspect of the invention, there is provided the above computer system development tool further including a set of server side source code files for interaction with the subroutines of the source code sample files to demonstrate the interoperation of the subroutines of the source code sample files with the server application program interfaces.

According to another aspect of the invention, there is provided a computer program product including a computer usable medium having computer readable program code means embodied in said medium for use in managing the interoperability between a set of client applications and a set of server applications where each of the set of client applications, and each of the set of server applications, is written to conform to a selected one of a set of application program interfaces, said computer program product having computer readable program code including a collection of source code sample files, each of the source code sample files conforming to a target one of the set of client application program interfaces and including a subroutine section having subroutines exemplifying successful interoperation between the target client application program interface and each of the set of differing server application program interfaces, a conditional statement section including source code reflecting the applicability of the subroutines in the subroutine section to the permutations of client application program interface and server application program interface interoperation, and an index section including an index of the subroutines in the subroutine section.

According to another aspect of the invention, there is provided the above computer program product, the computer readable program code further including a set of server side source code files for interaction with the subroutines of the source code sample files to demonstrate the interoperation of the subroutines of the source code sample files with the server application program interfaces.

Advantages of the present invention include the ability for a developer to manage interoperability issues between different application programming interfaces by accessing a library of interoperability source code which may be tested out and used to construct systems which avoid interoperability conflicts.

### BRIEF DESCRIPTION OF THE DRAWINGS

The preferred embodiment of the invention is shown in the drawings, wherein:

FIG. 1 is a block diagram showing potential interaction between example APIs for clients and servers.

FIG. 2 is a block diagram showing the structure of a source code sample file, according to the preferred embodiment of the invention.

In the drawings, the preferred embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

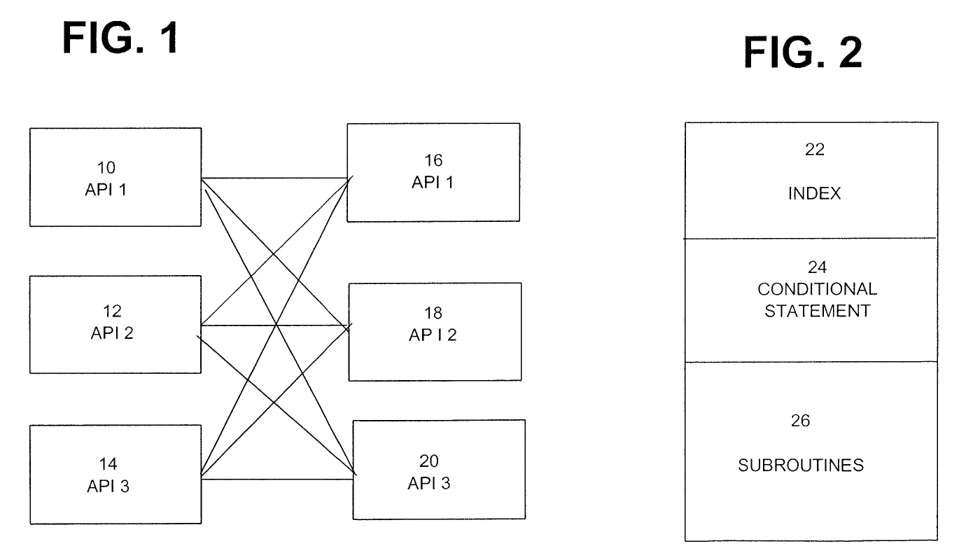

FIG. 1 is a block diagram illustrating the potential interaction between different client and server APIs. Boxes 10, 12, 14 represent API implementations for API 1, API 2, API 3, respectively, for client applications. Similarly, boxes 16, 18, 20 represent server applications having APIs 1, 2, 3, respectively. As is shown by the lines connecting the various client APIs, 10, 12, 13 to the server APIs 16, 18, 20 for the 3 APIs shown as examples in FIG. 1, there are 9 possible connections between the 2 sets of three applications.

Where, for example, a system developer seeks to write an application using client API 2 (box 12), to communicate with server API 3 (box 20), the application developer must consult documentation which sets out potential interoperability issues arising from the interaction of programs written in accordance with the two different APIs.

According to the preferred embodiment, a set of source code sample files is created for the APIs of interest. The structure of an example source code sample file for an API is shown in the example block diagram of FIG. 2. FIG. 2 shows the source code sample file having an index section 22, a conditional statement section 24 and a subroutine section 26.

According to the preferred embodiment, the source code sample file for a given API provides a set of sample source code subroutines defining interoperability techniques to be adopted by a system developer encoding the client system for the given API.

For example, for a back end application system which is a relational database management system, it is typical to provide access by way of stored procedures. Turning to the example of FIG. 1, where a developer is developing a client system in API 1, the developer will make use of the provided source code sample file written for that API (API 1). The API 1 source code sample file contains subroutines written in API 1 which model the successful calls to stored procedures as implemented in API 2, for example, on the server systems for the relational database management system (RDBMS).

In the source code sample files provided in the preferred embodiment, index 22 includes references to interoperability issues relating to the potential stored procedure calls available for the RDBMS. Index 22 permits the developer to locate statements found in conditional statement section 24 of the source code sample file. Conditional statement section 24 is defined in the language of API 1 and includes logic that reflects the interoperability constraints imposed by code written for API 1 accessing server systems that use API 2 or API 3. In other words, a series of statements (typically including a number of conditional statements such as IF statements) indicate whether interoperability is possible, and if so the name of a source code sample subroutine provided in the sample file for the APIs in question is provided. Where a statement in conditional statement section 24 makes reference to a subroutine, the subroutine is defined in subroutine section 26 of the source code sample file, for the example referred to above. The subroutines in subroutine section 26 include sample calls to the stored procedures available in the API 2 and API 3 implementation of the RDBMS.

Once a system developer has located the appropriate subroutine in the source code sample file shown in FIG. 2, the developer is able to copy the subroutine to the developer's source code file (written for API 1) and to make the appropriate modifications to the subroutine to match the needs of the developer in defining the client system implementation.

In this way, the system developer need not consult documentation tables setting out interoperability characteristics relating to the APIs of interest, but is able to effectively and simply move to the implementation of subroutines which will provide interoperability between the client implemented using the API for the client side and the server system implemented using the API for the server system.

In addition, in the preferred embodiment, source code is also provided for the server side to implement a sample server function. In this way, it is possible to execute the subroutines in the source code sample file on a sample server implementation. The ability to run the sample source codes on both the client side and the server side permits the developer to confirm that the subroutines provided in the source code sample file work in the environment in which the developer is implementing the desired client system.

Although the above example is described with reference to a database back end system and to stored procedure access to that database back end system, it will be understood by those skilled in the art that the approach of the preferred embodiment permits source code sample files to be created for any set of desired APIs relating to specified application systems.

An example of how the sample source code file of the preferred embodiment is used in implementing an SQLJ API client application (embedded SQL in Java) ling an SQL stored procedure on the server side called MY_NEW_PROC, is given below.

According to the preferred embodiment, an SQLJ source code sample file is provided. The developer will be able to use the index in the SQLJ sample source code file (corresponding to index 22 shown in FIG. 2). In the example presented here, the index contains the following 2 entries (amongst other entries relating to other interoperability issues):

outParameter: return median salary of EMPLOYEE

table Parameter types used: OUT DOUBLE

OUT INTEGER

OUT CHAR(32)

decimalType: pass and receive a DECIMAL data type from a stored procedure

Parameter types used: INOUT DECIMAL

These entries in the index indicate that the outParameter subroutine and the decimalType subroutine are subroutines relating to parameter passing. In the example presented here, the stored procedure named MY_NEW_PROC written in SQL returns OUT parameters having double, decimal, integer and char (255) data types. The outParameter and decimalType subroutines are therefore of interest to the developer. The developer therefore searches the conditional statements section of the SQLJ source code sample file (shown as section 24 in FIG. 2) to locate the statements relating to these two subroutines. Example entries in the conditional statement section are presented below:

```
//All server APIs can pass OUT parameters.
//All server APIs support DOUBLE, INTEGER,
//and CHAR data types.
outMedian = outParameter(con);
//Java and SQL procedures can handle DECIMAL data
types if (language.trim() .equals(“SQL”) ||
  language.trim().equals (“JAVA”))
{
  decimalType(con);
}
```

As will be seen, the conditional section in this example indicates that all server APIs support data types double, integer and char and that Java and SQL procedures can handle decimal types. A developer is therefore able to confirm that the call to SQL from SQLJ for a stored procedure having OUT parameters of data type double, decimal, integer and char (255) will be able to be implemented and that the outParameter subroutine and a decimalType subroutine will provide information regarding the interoperability of the APIs in question.

The developer therefore is able to make use of the Java language sample source code in SQLJ provided in the subroutines section of the source code sample file (corresponding to subroutine section 26 in FIG. 2).

An example of such a sample subroutine is set out below:

public static double outParameter (Connection con) throws SQLException

```
  {
    double median = 0;
    try
    {
      int outErrorCode = 0;
      String outErrorLabel = “”;
      String procName = “OUT_PARAM”;
      //call the stored procedure
    System.out.println (“\nCall stored procedure name
” +
          procName);
      #sql { CALL OUT_PARAM(:out median, :out
outErrorCode, :out
          outErrorLabel) };
      if (outErrorCode == 0)
      {
      System.out.println(procName + “ completed
successfully”) ;
      System.out.prntln (“Median salary returned from
” +
        procName + “ = ” + median);
      }
      else
      { // stored procedure failed
      System.out.println (procName + “ failed with
SQLCODE”
        + outErrorCode);
      System.out.println (procName + “ failed at ” +
          outErrorLabel);
      }
    }
    catch (SQLException sqle)
  {
    System.out.println(sqle);
  }
    return (median) ;
}
```

This sample code acts as a template or model that is available for the developer to use in creating the client application in SQLJ. The developer will then customize the sample code found in the subroutine section of the source code sample file. An example of such customized code is set out below:

public static double outParameter (Connection con) throws SQLException

```
{
    double median = 0;
    try
    {
        int outErrorCode = 0;
        String outErrorLabel = “”;
        String procName = “MY_NEW_PROC”;
    //declare and initialize output variable
    BigDecimal outDecimal = new BigDecimal
    (“0.00”)
    //call the stored procedure
    System.out.println (“\nCall stored procedure
    name ” + procName);
    #sql { CALL MY_NEW_PROC (:out median, :out
    outDecimal, :out
      outErrorCode, :out outErrorLabel) };
    if (outErrorCode == 0)
    {
      System.out.println(procName + “ completed
    successfully”);
      System.out.println (“Median salary returned from
    ” + procName +
        “ = ”+ median);
      System.out.println (“Decimal value returned from
    ” + procName +
        “ = ” + outDecimal);
    }
    else
    { // stored procedure failed
      System.out.println(procName + “ failed with
    SQLCODE ”+
        outErrorCode);
    System.out.println(procName + “ failed at ”
    +outErrorLabel);
    }
}
catch (SQLException sqle)
{
  System.out.println (sqle);
}
return (median) ;
}
```

As will be seen, the method defined has been customized to refer to MY_NEW_PROC and the output variable outDecimal is defined in the line “BigDecimal outDecimal=new BigDecimal (“0.00”);” This initialization is taken from the decimal type subroutine defined in the subroutines section of the source code (not shown).

As will be appreciated, the customization carried on the sample source code may well be considerable to meet the requirements of the developer in coding the client application. However, the information that the communication between the client and server is able to be successfully carried out, is presented to the developer in a useful manner. The developer is also able to use the source code sample as a basis for the client application code which is being developed. The developer will have an assurance that the call from the client API to the server API will execute correctly, by following the source code samples provided in the preferred embodiment.

Although a preferred embodiment of the present invention has been described here in detail, it will be appreciated by those skilled in the art, that variations may be made thereto. Such variations may be made without departing from the spirit of the invention or the scope of the appended claims.

The embodiments of the invention in which an exclusive property or privilege is claimed are defined as follows:

1. A computer system development tool for managing the interoperability of differing application program interfaces, the computer system comprising a source code sample file written for a first application program interface and comprising subroutines defining successful interoperation with a second application program interface.

2. The computer system development tool of claim 1 in which the source code sample file further comprises a conditional statement section comprising source code reflecting the applicability of the subroutines in the subroutine section to the permutations of client application program interface and server application program interface interoperation.

3. The computer system development tool of claim 2 further comprising an index section comprising entries referring to the source code logic blocks in the conditional statement section.

4. A computer system development tool for managing the interoperability between a set of client applications and a set of server applications where each of the set of client applications, and each of the set of server applications, is written to conform to a selected one of a set of application program interfaces, the computer system development tool comprising a collection of source code sample files, each of the source code sample files conforming to a target one of the set of client application program interfaces and comprising a subroutine section having subroutines exemplifying successful interoperation between the target client application program interface and each of the set of differing server application program interfaces, a conditional statement section comprising source code reflecting the applicability of the subroutines in the subroutine section to the permutations of client application program interface and server application program interface interoperation, and
an index section comprising an index of the subroutines in the subroutine section.

5. The computer system development tool of claim 4, further comprising a set of server side source code files for interaction with the subroutines of the source code sample files to demonstrate the interoperation of the subroutines of the source code sample files with the server application program interfaces.

6. A computer program product comprising a computer usable medium having computer readable program code means embodied in said medium for use in managing the interoperability between a set of client applications and a set of server applications where each of the set of client applications, and each of the set of server applications, is written to conform to a selected one of a set of application program interfaces, said computer program product having computer readable program code comprising a collection of source code sample files, each of the source code sample files conforming to a target one of the set of client application program interfaces and comprising;
a subroutine section having subroutines exemplifying successful interoperation between the target client application program interface and each of the set of differing server application program interfaces,
a conditional statement section comprising source code reflecting the applicability of the subroutines in the subroutine section to the permutations of client application program interface and server application program interface interoperation, and
an index section comprising an index of the subroutines in the subroutine section.

7. The computer program product of claim 6, the computer readable program code further comprising a set of server side source code files for interaction with the subroutines of the source code sample files to demonstrate the interoperation of the subroutines of the source code sample files with the server application program interfaces.
